(19) United States
(12) Patent Application Publication
(10) Pub. No.: US 2017/0344977 A1
(43) Pub. Date: Nov. 30, 2017

(54) Smart Wallet

(71) Applicant: Michael Joseph Jersa, III, Wildwood, MO (US)

(72) Inventor: Michael Joseph Jersa, III, Wildwood, MO (US)

(73) Assignee: The Watchtower Company, Chesterfield, MO (US)

(21) Appl. No.: 15/462,862

(22) Filed: Mar. 19, 2017

Related U.S. Application Data
(60) Provisional application No. 62/343,173, filed on May 31, 2016.

(51) Int. Cl. G06Q 20/36; G06K 9/00; G06K 7/14; G06K 19/06; G06Q 20/32; G06Q 10/10

(52) U.S. Cl. CPC G06Q 20/36; G06Q 20/3223; G06Q 10/10; G06K 7/1413; G06K 19/06028; G06K 9/00442; G06K 19/06112

(57) ABSTRACT

A method and apparatus for coupling electronic components to a smart wallet is disclosed. At least one compartment, the at least one compartment adapted to receive cash, a scanning device, the scanning device adapted to scan a document, and a display screen in electronic communication with the scanning device, the display screen adapted to display the document are also disclosed.

### FIELD OF THE INVENTION

This invention relates to an electronic wallet, and more particularly to a method and apparatus for coupling an electronic device to the electronic wallet.

### BACKGROUND OF THE INVENTION

Most people employ wallets for storing currency and documents. A traditional wallet comprises a plurality of compartments that are each adapted to receive cash, credit cards, driving license, insurance cards, business cards, and the like. Consequently, it may be cumbersome for a user to carry a wallet containing various physical documents. Moreover, when it is required to locate a specific document, the user is required to sequentially sift through several documents before finding the intended document in the wallet. The problem becomes more severe when several documents are aggregated together, thereby creating a particularly bulky wallet. In addition, it may be arduous for the user to constantly replace each document that is contained in the wallet when it becomes worn out over a period of time.

In one aspect of the invention, a smart wallet is described. The smart wallet comprises at least one compartment, the at least one compartment adapted to receive cash. The smart wallet further comprises a scanning device, the scanning device adapted to scan a document, and a display screen in electronic communication with the scanning device, the display screen adapted to display content of the document.

In another aspect of the invention, a smart wallet is described. The smart wallet comprises at least one compartment, the at least one compartment adapted to receive cash. An electronic receiver is coupled to the smart wallet, the electronic receiver adapted to receive a first electronic signal from an electronic device. A display screen is in electronic communication with the electronic receiver, the display screen adapted to display at least a portion of the first electronic signal.

In another aspect of the invention, a smart wallet is described. The smart wallet comprises at least one compartment, the compartment adapted to receive cash. The smart wallet comprises a memory unit, the memory unit adapted to store at least one of credit card data gift data, patient data, driving license data, security gate electronic access data elevator floor authorization data and insurance data. The memory unit is in electronic communication with an external scanning device to facilitate extracting at least one of the credit card data, the gift card data, the patient data, the driving license data, the security gate electronic access data, the elevator floor authorization data, and the insurance data by the external scanning device.

In another aspect of the invention, a smart wallet is described. The smart wallet comprises at least one compartment and a memory unit. The at least one compartment is adapted to receive cash. The smart wallet comprises a display screen in electronic communication with the memory unit, and a touch screen selector in electronic communication with the display screen, the touch screen selector adapted to provide access to a user when one of a user's fingerprint matches with the user's fingerprint that is stored within the memory unit and a first unique drawing pattern that is keyed by the user matches with a second unique drawing pattern that is stored within the memory unit.

In another aspect of the invention, a smart wallet is described. The smart wallet comprises at least one compartment, the at least one compartment adapted to receive cash. The smart wallet comprises a display screen, and an electronic receiver in electronic communication with the display screen. The electronic receiver is in electronic communication with a device worn by a user, the electronic receiver adapted to provide access to an operating system of the smart wallet to the user when the device worn by the user is lesser than a pre-programmed displacement from the electronic device.

In another aspect of the invention, a smart wallet is described. The smart wallet comprises at least one compartment, the at least one compartment adapted to receive cash. The smart wallet comprises one of an electronic receiver and an electronic keypad coupled to the smart wallet, one of the electronic receiver and the electronic keypad adapted to receive financial information pertaining to a household budget, one of the electronic receiver and the electronic keypad further adapted to receive financial information pertaining to actual currency spent. A memory unit is in electronic communication with one of the electronic receiver and the electronic keypad, the memory unit adapted to store financial information pertaining to the household budget and financial information pertaining to actual currency spent. A control unit is in electronic communication with the memory unit, the control unit adapted to subtract the financial information pertaining to actual currency spent from the financial information pertaining to the household budget. A display screen is in electronic communication with the control unit, the display screen adapted to display thereby notifying a user when one of the financial information pertaining to actual currency spent approaches the financial information pertaining to the household budget, and the financial information pertaining to actual currency spent equals/exceeds the financial information pertaining to the household budget.

In another aspect of the invention, a smart wallet is described. The smart wallet comprises at least one compartment, the at least one compartment adapted to receive cash. The smart wallet comprises a memory unit, the memory unit adapted to store information pertaining to at lease one merchant, a control unit in electronic communication with the memory unit, one of a selector option switch and a touch screen selector in electronic communication with the control unit, one of the selector option switch and the touch screen selector operable by a user to select the at least one merchant, and a display screen in electronic communication with the control unit, the display screen adapted to display at least one of a list of recent financial transactions associated with the at least one merchant and total currency that is due to be paid by the at least one merchant.

In yet another aspect of the invention, a smart wallet is described. The smart wallet comprises at least one compartment, the at least one compartment adapted to receive cash, and at least one component, the at least one component comprising a heart rate transducer, a fitness tracker, a digital music player, an electrically powered heating element, a flash light, a camera, a microphone, a GPS device, and an AM/FM radio receiver.

Other objects and features of the invention will be in part apparent and in part pointed out hereinafter.

### BRIEF DESCRIPTION OF THE DRAWING

FIG. 1 is a schematic representation of an electronic device in electronic communication with a smart wallet.

### DETAILED DESCRIPTION OF THE INVENTION

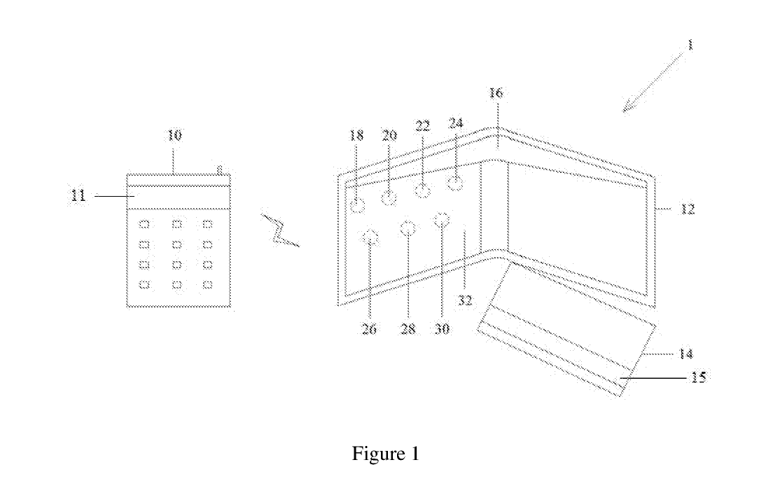

FIG. 1 is a schematic representation 1 of an electronic device 10 in electronic communication with a smart wallet 12. More specifically, in the exemplary embodiment, the electronic device 10 is in electronic communication with the smart wallet 12. The electronic device 10 may be any type of device known in the art that may be capable of electronically communicating with the smart wallet 12. In an exemplary embodiment, the electronic device 10 includes but is not limited to a mobile phone, a wrist watch, a pager, a remote control device, a Bluetooth® device, a CDMA device, a radio device, a computer system, a Wi-Fi enabled device, a GPS enabled device, a tracking device, and the like. The smart wallet 12 may be any type of electronic device that may be carried by a user, wherein the smart wallet 12 may be used to store and display data in electronic form.

The smart wallet 12 comprises at least one compartment 16 that is provided within the smart wallet 12. The at least one compartment 16 that is provided within the smart wallet 12 is adapted to receive and store cash. The smart wallet 12 contains a scanning device 32 that may be integrated within the smart wallet 12. The scanning device 32 may be adapted to scan a document that is placed on the smart wallet 12. In an embodiment, the scanning device 32 may be a flatbed scanner. In an alternate exemplary embodiment, the scanning device 32 may be one of a sheetfed scanner, a photoscanner, a handheld scanner, a drum scanner, and the like. In an embodiment, the scanning device 32 may be adapted to scan the document after the document is placed on the smart wallet 12 and the smart wallet 12 is closed by folding the smart wallet 12 about its center. In an alternate exemplary embodiment, the scanning device 32 may be adapted to scan the document after the document is placed on the smart wallet 12. In yet another alternate exemplary embodiment, the scanning device 32 is adapted to scan the document when the document is fed through the scanning device 32. The document that is scanned by the scanning device 32 may be one of an invoice, a receipt, a promotional coupon, a business card, a credit card, a driving license, a car registration document, an insurance card, a visiting card, a hospital identity card, a social security card, a Government issued identity card, and a passport. The document that is scanned by the scanning device 32 may be any other document that is known in the art. In addition, the scanning device 32 that is coupled to the smart wallet 12 may be adapted to scan the document via any other means that is known in the art. The scanning device 32 includes information gathering means/image processing means for obtaining data from documents.

A display screen 28 is in electronic communication with the scanning device 32. More specifically, the display screen 28 is positioned adjacent to the scanning device 32 in the smart wallet 12. The display screen 28 is adapted to display the document that has been scanned by the scanning device 32 for a user to view. The smart wallet 12 may be closed by folding the smart wallet 12 between the scanning device 32 and the display screen 28 and scanning the document thereafter. Alternatively, the smart wallet 12 may be closed by folding the display screen 28 about a joint that may be provided in the display screen 28. Alternatively, the display screen 28 may be folded to facilitate closing the smart wallet 12.

The display screen 28 may be positioned anywhere on the smart wallet 12 that allows the user to conveniently view the subject matter that has been scanned by the scanning device 32. A fastener (not shown) may be provided in the smart wallet 12. In an exemplary embodiment, the fastener may be a clip, or any other gripping/securing mechanism known in the art that facilitates securing the document to the scanning device 32 of the smart wallet 12. The fastener may be adapted to secure the document against the scanning device 32 firmly to facilitate scanning the document by the scanning device 32. A touch screen selector is in electronic communication with the display screen 28. The touch screen selector may be operated upon by a user by placing a user's finger on the display screen 28 to facilitate extracting a user's fingerprint by the smart wallet 12. A memory unit 30 may be in electronic communication with one of the scanning device 32 and the display screen 28. The user's fingerprint is then compared with a fingerprint of the user that is stored within the memory unit 30 of the smart wallet 12. If the user's fingerprint that is extracted by the smart wallet 12 from the user's finger matches with the fingerprint of the user that is stored within the memory unit 30 of the smart wallet 12, the user is granted access to an operating system of the smart wallet 12. In an alternate exemplary embodiment, the user may key a unique drawing pattern on the display screen 28 of the smart wallet 12. If the unique drawing pattern that is keyed by the user matches with a drawing pattern of the user that is stored within the memory unit 30 of the smart wallet 12, the user is granted access to the operating system of the smart wallet 12.

In an alternate exemplary embodiment, the smart wallet 12 may grant access to the user when the smart wallet 12 is proximate to a device that is worn by the user such as but not limited to a finger ring, a pendent, a bracelet, a mobile phone, a watch, and a clip. More specifically, the device that is worn by the user may be in electronic communication with an electronic receiver 18 of the smart wallet 12. When the device that is worn by the user is lesser than a pre-programmed displacement, the electronic receiver 18 facilitates granting access to the operating system of the smart wallet 12. If the device that is worn by the user is greater than the pre-programmed displacement, access to the operating system of the smart wallet 12 is not granted.

In an exemplary embodiment, the memory unit 30 may be in electronic communication with an electronic receiver of the smart wallet 12 and acquires and stores the electronic signal from the electronic receiver 18. More specifically, the memory unit 30 may acquire and store a finite list of entries that include a finite number of log entries that may be received from the electronic device 10. The memory unit 30 automatically deletes the oldest of the stored log entries in chronological order as the latest log entries are continuously acquired and stored by the memory unit 30 from the electronic receiver 18. In an alternate exemplary embodiment, the memory unit 30 may be interchangeable with any memory unit 30 such as but not limited to a computer chip, an integrated circuit, a memory card, a memory stick, a memory device, and a magnetic medium. In an exemplary embodiment, the smart wallet 12 may be provided with a slot/USB port (not shown) on an outer sidewall of the smart wallet 12 for receiving the memory unit 30 therein.

The smart wallet 12 may be any type of wireless/wired electronic communication device known in the art that may be capable of transmitting/receiving electronic signals to/from the electronic device 10. Moreover, the smart wallet 12 may be any type of electronic device that may be capable of being carried by the user such as in a user's pocket, a user's bag, and the like. The electronic communication between the electronic device 10 and the smart wallet 12 is explained in further detail below.

In the exemplary embodiment, the electronic device 10 includes an electronic transmitter (not shown). The electronic transmitter may be adapted to be integrated within the electronic device 10 and transmits an electronic signal to the electronic receiver 18 that may be adapted to be coupled to the smart wallet 12. Specifically, the electronic signal transmitted by the electronic transmitter of the electronic device 10 to the smart wallet 12 is transmitted to notify the user of the smart wallet 12 of the electronic signal. In an alternate exemplary embodiment, the electronic signal transmitted by the electronic transmitter of the electronic device 10 to the electronic receiver 18 of the smart wallet 12 may be transmitted to facilitate initiating electronic communication between the electronic device 10 and the smart wallet 12. The initiation of electronic communication between the electronic device 10 and the electronic receiver 18 that may be adapted to be coupled to the smart wallet 12 allows for data retrieval from the smart wallet 12 in an exemplary embodiment, the data retrieved from the smart wallet 12 may correspond to data retrieved from at least one electronic component 22 that may be adapted to be coupled to the smart wallet 12 and in electronic communication with the electronic receiver 18. In an exemplary embodiment, the electronic signal transmitted by the electronic transmitter of the electronic device 16 to the electronic receiver 18 may be at least one of a credit card signal, a driving license signal, a car registration signal, an insurance signal, a medical record signal, a linked credit card signal, a business card signal, a barcode signal, a store card signal, a social security data signal, a household budget signal, a current altitude signal, a current local temperature signal, a current local pressure signal, a current stock ticker signal, a current sport score signal a current news flash signal, a video conferencing signal, a social media notification signal, an advertisement signal, a GPS navigation signal, an e-mail notification signal, a birthday notification signal, a calendar appointment signal, and a weather notification signal. Each of the plurality of electronic signals that are indicated above may be transmitted from the electronic transmitter of the electronic device 10 to the electronic receiver 18 of the smart wallet 12 to notify the user of the smart wallet 12 of each of the plurality of electronic signals. The display screen 28 may be in electronic communication with the electronic receiver 18. More specifically, the display screen 28 that may be in electronic communication with the electronic receiver 18 of the smart wallet 12 facilitates displaying each of the plurality of electronic signals received by the electronic receiver 18 of the smart wallet 12 from the electronic transmitter of the electronic device 10.

In an exemplary embodiment data retrieved from the smart wallet 12 may correspond to data retrieved from at least one electronic component 22 that may be adapted to be coupled to the smart wallet 12 and in electronic communication with the electronic receiver of the electronic device 10. The electronic receiver may be integrated within the electronic device 10 and receives an electronic signal from the smart wallet 12. Specifically, the electronic receiver of the electronic device 10 may be in electronic communication with an electronic transmitter 20 that may be coupled to the smart wallet 12 and receives the electronic signal that is transmitted from the electronic transmitter 20. In an exemplary embodiment, the electronic receiver of the electronic device 10 may be a wireless radio receiver, a wireless Bluetooth® receiver, a wireless CDMA receiver, and the like depending on a signal range required by the user for receiving the electronic signal from the electronic transmitter 20. Alternatively, the electronic receiver of the electronic device 10 may be any type of wireless electronic receiver known in the art that receives an electromagnetic signal from the electronic transmitter 20. The electronic signal that may be received by the electronic receiver of the electronic device 10 from the electronic transmitter 20 that may be coupled to the smart wallet 12 may be used to determine the geographical location of the smart wallet 12 with respect to the electronic device 10. In an alternate exemplary embodiment, the electronic signal that may be retrieved by the electronic receiver of the electronic device 10 comprises data retrieved from at least one electronic component 22 that may be adapted to be coupled to the smart wallet 12. The at least one electronic component 22 that may be adapted to be coupled to the smart wallet 12 may be in electronic communication with the electronic transmitter 20. More specifically, the electronic transmitter 20 of the smart wallet 12 may be adapted to transmit data retrieved from at least one electronic component 22 to the electronic receiver of the electronic device 10. A control unit 24 may be in electronic communication with the electronic transmitter 20 of the smart wallet 12 and facilitates activating the electronic transmitter 20 of the smart wallet 12 to transmit data retrieved from at least one electronic component 22 to the electronic receiver of the electronic device 10. In an exemplary embodiment, the electronic transmitter 20 of the smart wallet 12 may be adapted to transmit data comprising at least one of a notification signal that the document is about to expire. In an alternate exemplary embodiment, the electronic transmitter 20 of the smart wallet 12 may be adapted to transmit a smart messaging service (SMS) signal. Moreover the control unit 24 may be in electronic communication with the electronic receiver 18 of the smart wallet 12.

When the smart wallet 12 exceeds a displacement that has deco programmed by the user, the electronic receiver of the electronic device 10 receives an electronic signal from the electronic transmitter 20 of the smart wallet 12 that may be indicative that the smart wallet 12 has exceeded the displacement. Specifically, when the smart wallet 12 exceeds the displacement that has been programmed by the user, a signal strength established between the electronic receiver of the electronic device 10 and the electronic transmitter 20 of the smart wallet 12 decreases. The decrease in signal strength may be indicative that the smart wallet 12 has exceeded the displacement.

In an alternate embodiment, the timed exchange of data packets between the electronic receiver of the electronic device 10 and the electronic transmitter 20 of the smart wallet 12 may be another technique employed to determine that the smart wallet 12 has exceeded the displacement. Specifically, an effective roundtrip time between data packets transmitted from the electronic device 10 to the smart wallet 12 and data packets transmitted from the electronic transmitter 20 of the smart wallet 12 to the electronic receiver of the electronic device 10 may be used to determine tat the smart wallet 12 has exceeded the displacement. In further alternate embodiments such as but not limited to Wi-Fi positioning, fingerprinting, RSSI localization technique, GPS map displacement measurement technique, angle of arrival, time of flight localization technique, and the like may be used to determine that the smart wallet 12 has exceeded the displacement. Alternatively, any method that is known in the art may be employed to determine that the smart wallet 12 has exceeded the displacement.

In an exemplary embodiment, that smart wallet 12 may be used to make payments via an application in the smart wallet 12. As an example, the smart wallet 12 may contain an application such as but not limited to “Apple Pay” and “Google Wallet”. When the user selects the application on the smart wallet 12, the smart wallet 12 may be used to select a product pertaining to a user's choice. Therein, the user may pay for the product by means of the application that is present in the smart wallet 12.

A control unit may be adapted to be coupled to the electronic device 10. Specifically, the control unit may be adapted to be coupled to the electronic transmitter and to the electronic receiver of the electronic device 10.

In an exemplary embodiment, the smart wallet 12 includes a battery compartment (not shown). More specifically, the battery compartment may be adapted to be provided within a recess defined within the smart wallet 12. In an alternate exemplary embodiment, the battery compartment may be adapted to be coupled to the electronic device 10. The battery compartment comprises at least one pair of positive and negative polarity electrical leads(not shown). The positive and negative polarity electrical leads receive a rechargeable battery therein. The control unit 24 may be in electronic communication with the positive and negative polarity electrical leads via a control flow path to constitute a closed loop electrical circuit. In an exemplary embodiment, power supplied by the rechargeable battery to the positive and negative polarity electrical leads powers the control unit 24. Therefore, all electronic components such as the electronic receiver 18, electronic transmitter 20, display screen 28, memory unit 30, scanning device 32, Etc. that have been integrated/coupled to the smart wallet 12 and in electronic communication with the control unit 24 may be electrically powered by the power supplied to the positive and negative polarity electrical leads by the rechargeable battery.

The smart wallet 12 comprises a credit card/gift card 14 with a magnetic stripe element 15 integrated with the credit card/gift card 14. The credit card/gift card 14 comprises a card body and the magnetic stripe element 15 detachable coupled thereto. The magnetic stripe element 15 may be programmed by the user to acquire information on a particular credit card/gift card from a variety of credit cards/gift cards that are programmed in the smart wallet 12. When the magnetic stripe element 15 is not programmed by the user, the magnetic stripe element 15 does not contain any data that may be accessed from an external credit card scanning device. If a user desires to use another credit card/gift card, the information relating to the particular credit card/gift card may be erased and replaced with information relating to the other credit card/gift card. The card body may be made of a sufficiently firm material preferably plastic material with a storage medium in the form of the magnetic stripe-element 15/memory chip (not shown). The magnetic stripe element 15 has an adhesive layer which allows it to be detached from the card body and replaced as the magnetic stripe element 15 gets periodically worn out. In an alternate exemplary embodiment, the magnetic stripe element 15 of the credit card/gift card 14 may be detachably coupled to the smart wallet 12 without employing a card body. In a further alternate exemplary embodiment, the magnetic stripe element 15 of the credit card/gift card 14 may be retractably coupled to the smart wallet 12 without employing a card body. Moreover, the credit card/gift card 14 that may be coupled to the smart wallet 12 includes a display panel (not shown) that may be coupled to an outer surface of the credit card/gift card 14. The display panel may be coupled to one of a front panel and a rear panel of the credit card/gift card 14 and digitally displays an available line of credit on the credit card/gift card 14 in real time. More specifically, each time that the credit card/gift card 14 has been used to perform a financial transaction, a transaction amount is subtracted from the available line of credit on the credit card/gilt card 14. Therein, the display panel displays the new available line of credit on the credit card/gift card 14 after the financial transaction has been completed.

The smart wallet 12 includes an electronic keypad that may be coupled to the smart wallet 12. More specifically, the electronic keypad may be a digital touch screen keypad provided on the smart wallet 12 integral/independent from the smart wallet 12. One of the electronic receiver 18 and the electronic keypad may be adapted to receive financial information pertaining to a household budget. Specifically, financial information pertaining to the household budget may be keyed on the electronic keypad/received by the electronic receiver 18 from the electronic transmitter of the electronic device 10. Moreover, one of the electronic keypad and the electronic receiver 18 may be adapted to receive financial information pertaining to actual currency spent by the user. The memory unit 30 of the smart wallet 12 may be in electronic communication with one of the electronic keypad/electronic receiver 18 of the smart wallet 12. The memory unit 30 may be adapted to store financial information pertaining to the household budget that may be keyed on the electronic keypad/received by the electronic receiver 18 from the electronic transmitter of the electronic device 10 as well as financial information pertaining to actual currency spent by the user. Moreover, one of the electronic receiver 18 and the electronic keypad may be adapted to receiver financial information pertaining to cash spent by the user from the smart wallet 12. The memory unit 30 may be adapted to store financial information pertaining to cash spent by the user. The term “cash” as described herein refers to “paper currency” that may be spent by the user.

The control unit 24 may be in electronic communication with the memory unit 30. The control unit 24 may be adapted to subtract the financial information pertaining to actual currency spent from the financial information pertaining to the household budget. The display screen 28 may be in electronic communication with the control unit 24. The display screen 28 displays the financial information pertaining to actual currency spent and the financial information pertaining to the household budget. When the financial information pertaining to the actual currency spent approached the financial information pertaining to the household budget, the display screen 28 notifies the user by displaying the financial information pertaining to the actual currency spent and the financial information pertaining to the household budget as well as the excess/deficit currency after the subtraction. Moreover, when the financial information pertaining to the actual currency spent exceeds/equals the financial information pertaining to the household budget, the display screen 28 notifies the user by displaying the financial information pertaining to the actual currency spent and the financial information pertaining to the household budget. Moreover, the display screen 28 may indicate a warning when the actual currency spent equals/exceeds the financial information pertaining to the household budget. At an end of a pre-defined time period such as but not limited to an end of each month/end of a user defined business cycle, the display screen 28 may be adapted to display a consolidated statement of the financial information pertaining to actual currency spent at the end of the pre-defined time period.

In an embodiment, the memory unit 30 of the smart wallet 12 may be adapted to store information of at least one merchant. One of the selector option switch and the touch screen selector of the smart wallet 12 may be in electronic communication with the control unit 24. One of the selector option switch and the touch screen selector may be operable by the user to select a merchant from a list of merchants that are each stored in the memory unit 30. The display screen 28 may be adapted to display at least one of a list of recent transactions associated with the merchant and the total currency that is due to be paid by the merchant. A GPS device 26 may be coupled to the smart wallet 12 and adapted to determine a geographical location of the smart wallet 12. The control unit 24 may be in electronic communication with the GPS device 26, wherein one of the GPS device 26 and the control unit 24 may be adapted to determine if the geographical location of the smart wallet 12 is proximate to a merchant address of the merchant. The display screen 28 may be adapted to display thereby notifying the user if the geographical location of the smart wallet 12 is proximate to the merchant address of the merchant.

The electronic transmitter 28 may be adapted to transmit payment information pertaining to one of a utility bill, a credit card bill, and the like to the electronic device 10. In an alternate exemplary embodiment, the electronic transmitter 20 may be adapted to transmit the actual currency spent and the financial information pertaining to the household budget to the electronic device 10. In yet another alternate exemplary embodiment, the electronic transmitter 20 may be adapted to transmit any financial information from the smart wallet 12 to the electronic device 10 that may be contained in the smart wallet 12.

In an embodiment, the smart wallet 12 may be manufactured from leather, canvas, plastic, rexene, nylon, rubber, polyester, felt, silk, and the like. In an alternate exemplary embodiment, the smart wallet 12 may be manufactured from any material that is known in the art that allows the smart wallet 12 to be folded and inserted within a user's pocket.

In an exemplary embodiment, the electronic device 10 includes a display panel 11 that may be adapted to be coupled to an outer sidewall of the electronic device 10. More specifically, a touch screen selector may be adapted to be in electronic communication with the display panel 11 and may be operated by the user to display a location of the smart wallet 12 with reference to the electronic device 10. The display panel 11 may be adapted to be in electronic communication with the control unit of the electronic device 10. Moreover, the electronic receiver 18 of the smart wallet 12 may be adapted to be in electronic communication with the control unit of the electronic device 10. The location of the smart wallet 12 with reference to the electronic device 10 that may be displayed on the display panel 11 may be received in the electronic receiver of the electronic device 10 from the electronic transmitter 20 of the smart wallet 12. In an exemplary embodiment, the display panel 11 may be an LCD screen, TFT screen, TFT active matrix screen, black and white screen, CSTN screen, and a plasma screen. Alternatively, the display panel 11 may be any type of display panel known in the art that may be capable of displaying a location of the smart wallet 12 with reference to the electronic device 10. More typically, the electronic device 10 includes speakers, head phones or similar devices for producing an audio signal for the content displayed on the display panel 11 that may be received by the electronic receiver of the electronic device 10 from the electronic transmitter 20 of the smart wallet 12. The display panel 11 has a resolution from about 240×320 to 4B0×640 and preferably is a 16-18 bit color screen for displaying a location of the smart wallet 12 with reference to the electronic device 10. In an exemplary embodiment, the display panel 11 is adapted to be coupled to the electronic device 10. The display panel 11 is adapted to be coupled circumferentially to the electronic device 10 such that a portion of the electronic device 10 that includes various electronic transducers, switches, and the like do not constitute a portion of the display panel 11. In an alternate exemplary embodiment, all user selector options for running any application may be performed using the touch screen selector that may be in electronic communication with the display panel 11.

The at least one electronic component 22 may be adapted to be coupled to the control unit 24. In an exemplary embodiment, the at least one electronic component 22 may be a fitness tracker. The fitness tracker may detect a number of parameters pertaining to the user of the smart wallet 12. An electronic signal from the fitness tracker may be transmitted from the electronic transmitter 20 that may be coupled to the smart wallet 12 to the electronic receiver of the electronic device 10 that may be indicative of the parameters that have been detected by the fitness tracker. The control unit of the electronic device 10 may determine the parameters from the electronic signal that may be received by the electronic receiver of the electronic device 10 from the fitness tracker. The parameters include but are not limited to a number of steps traversed by the user, a time walked by the user, a distance that has been covered by the user, a distance that remains to be covered after the user has covered a certain distance, and a number of calories expended by the user. The control unit of the electronic device 10 facilitates digitally displaying the parameters on the display panel 11 to notify the user of the parameters that have been determined by the control unit. If the distance covered by the user is lesser than/greater than a distance that may be programmed in the electronic device 16 by the user, the user may be notified accordingly. In an alternate exemplary embodiment, the parameters may be displayed on the display screen 28 of the smart wallet 12 by means of the control unit 24 of the smart wallet 12.

During normal operation of the fitness tracker, a walking sensor in the fitness tracker detects the vibration or motion of the user's body at a time of walking to produce a signal output of one pulse at each walking step. The signal output of the walking sensor is inputted to a counter, which counts the number of the user's walking steps. When an indicator selection switch is selected to a walking step indication, the indicator indicates the content of the counter. When the indicated number of steps is desired to be reset to “0”, a resetter is arbitrarily operated to clear the content of the counter, thereby resetting the counter and indicating “0” on the indicator.

In an exemplary embodiment, the at least one electronic component 22 includes a heart rate transducer that may be adapted to be coupled to the smart wallet 12. More specifically, the heart rate transducer may be adapted to be coupled to the smart wallet 12, and determines a user's heart rate. An electronic signal from the heart rate transducer may be transmitted from the electronic transmitter 20 that may be coupled to the smart wallet 12 to the electronic receiver of the electronic device 10 that may be indicative of a heart rate of the user. The control unit of the electronic device 10 may determine the user's heart rate from the electronic signal that may be received by the electronic receiver of the electronic device 10 from the heart rate transducer. The control unit of the electronic device 10 facilitates digitally displaying the user's heart rate on the display panel 11 to notify the user. In an alternate exemplary embodiment, the heart rate of the user may be displayed on the display screen 28 of the smart wallet 12 by means of the control unit 24 of the smart wallet 12.

In an exemplary embodiment, the at least one electronic component 22 may be a digital camera and/or motion video recorder. More specifically, the digital camera and/or motion video recorder that may be adapted to be coupled to the smart wallet 12 allows the user to capture high resolution images and/or audio and video recordings of the surroundings around the user. The digital camera and/or motion video recorder may be adapted to be activated and deactivated by the user by means of the electronic device 10. The digital camera and/or motion video recorder may be coupled to the memory unit 30. More specifically, the memory unit 30 may store the captured images and/or audio and video recordings. An electronic signal from the digital camera and/or motion video recorder/memory unit 30 may be transmitted from the electronic transmitter 20 that may be coupled to the smart wallet 12 to the electronic receiver of the electronic device 10 that may be indicative of the surroundings around the user. The captured images and/or audio and video recordings may also be transmitted from the digital camera and/or motion video recorder to any electronic device known in the art such as but not limited to a personal computer, a wireless router, a smart watch, a Bluetooth® device, and a smart phone. The control unit may post-process the captured images and/or audio and video recordings that may be received from the digital camera and/or motion video recorder. The control unit of the electronic device 10 facilitates digitally displaying the surroundings around the user/images captured by the user on the display panel 11. The terms camera, digital camera, video camera, analog camera, motion video recorder, and the like may be construed to be used interchangeably to mean the same type of device. The memory unit 30 may be adapted to store one of credit card data, gift card data, patient data, driving license data, security gate electronic access data, elevator floor authorization data, and insurance data captured by one of the digital, camera/motion video recorder/scanning device 32. The memory unit 30 may be in electronic communication with an external scanning device. More specifically, the external scanning device may be used to extract one of credit card data, gift card data, patient data, driving license data, security gate electronic access data, elevator floor authorization data, and insurance data from the smart wallet 12 for the purpose of validation. In an alternate exemplary embodiment, the captured images, and/or video recordings and one of the credit card data, patient data, gift card data, security gate electronic access data, driving license data, elevator floor authorization data, and insurance data may be displayed on the display screen 28 of the smart wallet 12. In an exemplary embodiment, patient data may be but not limited to patient information such as medical history, past surgeries, allergies, prescriptions consumed by the patient, consulting physician, emergency contacts, and the like. The external scanning device may be any type of device that may be programmed to receive data from the memory unit 30 of the smart wallet 12 via near field communication, Bluetooth®, Wireless, and the like. The external scanning device may be but is not limited to another user's mobile phone, a credit card machine, an elevator security authorization device, a vehicle door, a building door, a doctor's office scanning device, a police patrol scanning device, and an insurance office scanning device. The use of this data transfer from the smart wallet 12 to the external scanning device may be limited by settings preset by the user in the smart wallet 12.

In an exemplary embodiment, the at least one electronic component 22 may be a barcode that may be coupled/integrated to the smart wallet 12. More specifically, the barcode may be adapted to be coupled to the smart wallet 12, and contains an identity of the user. An electronic signal from the barcode may be transmitted from the electronic transmitter 20 that may be coupled to the smart wallet 12 to the electronic receiver of the electronic device 10 that may be indicative of the identity of the user. The identity of the user may be a unique identification parameter associated with that user which differentiates it from unique identification parameters of other users who may possess smart wallets. The control unit of the electronic device 10 may determine the identity of the user from the electronic signal that may be received from the barcode. The control unit of the electronic device 10 facilitates digitally displaying the identity of the user on the display panel 11 to notify the user. Alternatively, the identity of the user may be extracted from the barcode by means of a barcode scanner, wherein the barcode scanner may be integrated within/coupled to the electronic device 10. The barcode scanner may also bean independent barcode scanning device.

In an exemplary embodiment the at least one electronic component 22 may be a microphone. More specifically, the microphone may be adapted to be coupled to the smart wallet 12, and captures an audible sound emitted from the user. An electronic signal from the microphone may be transmitted from the electronic transmitter 20 that may be coupled to the smart wallet 12 to the electronic receiver of the electronic device 10 that may be indicative of the audible sound that may be emitted from the user. The control unit of the electronic device 10 may determine the audible sound emitted from the user from the electronic signal that may be received from the microphone. The control unit of the electronic device 10 facilitates playing the audible sound that may be emitted from the user in the electronic device 10 to notify the user.

In an exemplary embodiment, the at least one electronic component 22 may be the GPS device 26. More specifically, the GPS device 26 may be adapted to be in electronic communication with the control unit 24 of the smart wallet 12, and determines a geographical location of the smart wallet 12. An electronic signal from the GPS device 26 may be transmitted from the electronic transmitter 20 that may be coupled to the smart wallet 12 to the electronic receiver of the electronic device 10 that may be indicative of the geographical location of the user. The control unit of the electronic device 10 may determine the geographical location of the smart wallet 12 from the electronic signal that may be received from the GPS device 26. The control unit of the electronic device 10 facilitates digitally displaying the geographic allocation of the smart wallet 12 on the display panel 11 to notify the user. In an alternate exemplary embodiment, the geographical location of the smart wallet 12 may be displayed on the display screen 28 of the smart wallet 12.

The at least one electronic component 22 may be an electrically powered heating element coupled to the smart wallet 12. Thus, as the electrically powered heating element of the smart wallet 12 is powered by electricity, the electrically powered heating element generates heat. The heat generated by the electrically powered heating element warms the user that is in contact with the smart wallet 12 when directed by the user either by means of a direct input or by means of the electronic device 10. In an alternate exemplary embodiment, an infrared heater may be adapted to be coupled to the smart wallet 12 to warm the user that is in contact with the smart wallet 12. The electrically powered heating element may alternatively be any heating source known in the art that facilitate warming the user that is in contact with the smart wallet 12.

The electrically powered heating element may be controlled by the user for a range of operations from mild warming to quick warming depending on the user's preference. More specifically, the smart wallet 12 may be provided with ascending power levels 1-5 and the like. By selecting the power level L the user may be warmed to a lower temperature by supplying the electrically powered heating element with low power. By selecting the power level 5, the user may be warmed to a higher temperature by supplying the electrically powered heating element with high power. Alternatively, the power levels 1-5 may signify the time taken to warm the user in ascending/descending order

In an exemplary embodiment, the at least one electronic component 22 may be a flash light. More specifically, the flash light may be adapted to be coupled to the smart wallet 12 and may emit a beam of light from a light source. More specifically, the flash light may be in electronic communication with a switch (not shown) that may be coupled to the smart wallet 12 and illuminates a path of the user when the switch may be operated by the user. In an exemplary embodiment, the flash light may be remotely activated by the user by means of the electronic transmitter that may be coupled to a switch of the electronic device 10 and in electronic communication with the electronic receiver 18 of the smart wallet 12. The flash light comprises a light bulb mounted on a reflector and a transparent cover to protect the light source. The reflector may be used to reflect the beam of light that may be emitted from the light source. The flash light facilitates illuminating a path along a line of-sight-of the user.

In an exemplary embodiment, the at least one electronic component 22 may be an AM/FM radio receiver that may be adapted to be coupled to the smart wallet 12. More specifically, the user may monitor a current radio station from the smart wallet 12, and toggle between various AM/FM radio stations using the touch screen selector that may be provided on the smart wallet 12. In an exemplary embodiment, the AM/FM radio receiver may be integrally or removably coupled to the smart wallet 12. The AM/FM radio receiver comprises a radio tuner having a radio frequency input and an audio output for providing a radio audio signal. The AM/FM radio receiver may be adapted to be coupled to the speaker. The radio audio signal may be transmitted from the AM/FM radio receiver to the speaker via a plurality of electronic modulating components for communicating the radio audio signal to the user. The volume level of the speaker may be increased or decreased by using the touch screen selector provided on the smart wallet 12.

In an exemplary embodiment, the at least one electronic component 22 may be a digital music player that may be adapted to be coupled to the smart wallet 12. More specifically, the user may select a desired song track from a plurality of song tracks stored in the memory unit 30, wherein the memory unit 30 may be in electronic communication with the digital music player. The digital music player may be adapted to be coupled to the speaker. A desired song track signal may be transmitted from the digital music player to the speaker in order to play the desired song track for the user. In an alternate exemplary embodiment, the digital music player may be remotely controlled by the user by transmitting an electronic signal from the electronic transmitter of the electronic device 10 to the electronic receiver 18 of the smart wallet 12. In an exemplary embodiment, when the plurality of light emitting sources/light emitting source displays various colors, flickers on and off in a sequence, strobes, cycles in various user programmed sequences, one of the radio tuner and the digital music player may be activated simultaneously for a pre-programmed duration of time. Alternatively, one of the radio tuner and the digital music player may be activated simultaneously and remains in operation until deactivated by the user by means of the electronic device 10. It may be understood by one skilled in the art that each of the at least one electronic components 22 described above may be in electronic communication with one another and with the electronic receiver 18 and the electronic transmitter 20 of the smart wallet 12.

In an exemplary embodiment, the smart wallet 12 may be manufactured from a water resistant material. Specifically, all of the electronic components that are adapted to be couple/integrated within the smart wallet 12 may be manufactured from the water resistant material/insulated within the water resistant material of the smart wallet 12 to facilitate insulating the smart wallet 12 from water caused by rain, water puddles, swimming pools, water bodies, bath tubs, and the like which the user may encounter.

In an exemplary embodiment, the smart wallet 12 may be manufactured using a rugged design/ruggedness imparting wear resistant material. Specifically, all of the electronic components that are adapted to be coupled/integrated within the smart wallet 12 may be manufactured from the wear resistant material/insulated within the wear resistant material of the smart wallet 12 to facilitate insulating the smart wallet 12 from wear caused by exposure to tough day-to-day environments which the user may encounter.

In an exemplary embodiment, the at least one electronic component 22 may be a Bluetooth® device (not shown) that may be adapted to be coupled to the smart wallet 12. The Bluetooth® device that may be coupled to the smart wallet 12 may be adapted to operate an accessory such as an elevator. Specifically, an electronic transducer that may be coupled to/proximate to the elevator may detect the Bluetooth® device and grant access for the user to travel to an authorized floor. The Bluetooth® device may be coupled to one of the electronic transmitter 20, electronic receiver 18, and the display screen 28.

In an exemplary embodiment the smart wallet 12 comprises a counterfeit currency bill detection scanner (not shown) that may be coupled to the smart wallet 12. More specifically, the counterfeit currency bill detection scanner scans a currency bill to validate whether a currency bill is genuine or counterfeit. More specifically, the control unit 24 may be in electronic communication with the counterfeit currency bill detection scanner and determines if the currency bill scanned by the counterfeit currency bill detection scanner is genuine or counterfeit. A corresponding message may be displayed on the display screen 28 of the smart wallet 12 indicating that the currency bill is genuine. Alternatively, a corresponding message may be displayed on the display screen 28 of the smart wallet 12 indicating that the currency bill is counterfeit. If the scanned currency bill is counterfeit, an audible warning signal may be provided to the user notifying that the scanned currency bill is counterfeit.

A touch screen selector may be adapted to be coupled to/integrated in the electronic device 10. In addition/alternatively, a selector option switch may be adapted to be coupled to the electronic device 10

The above described smart wallet 12 is cost effective and highly reliable. In addition, the modular nature of each sub-system of the smart wallet 12 facilitates easy disassembly and replacement of individual system components as required. The terms ‘in electronic communication with’, ‘electronically coupled’, ‘coupled to’, ‘connected’, ‘integrated’ and the like as described in the specification and in the claims may be construed to be used interchangeably. Moreover, the terms ‘may be’, ‘adapted to be’, ‘is’, ‘are’, and the like as described in the specification and in the claims may be construed to be used interchangeably.

In accordance with a recognized need, there has been developed a smart wallet 12 to satisfy many users' data gathering requirements. The electronic device 10 that may be located remotely from the smart wallet 12 is compact and easily interchangeable with electronic devices of various types such as cell phones, smart watches, pagers, remote control devices, Bluetooth® devices, CDMA devices, radio frequency devices, computer systems, and the like. It is a versatile device which can be used to receive/transmit electronic signals from/to the smart wallet 12, as well as perform the function of gathering data/parameters from the user via the smart wallet 12. Importantly, the smart wallet 12 is efficient in operation.

Exemplary embodiments of a smart wallet 12 are described above in detail. The system is not limited to the specific embodiments described herein, but rather, components of each system may be utilized separately and independently from other components described herein.

While the invention has been described in terms of various specific embodiments, those skilled in the art will recognize that the invention can be practiced with modifications within the spirit and scope of the claims.

What is claimed is;

1. A smart wallet, said smart wallet comprising:
at least one compartment, said at least one compartment adapted to receive cash;
a scanning device, said scanning device adapted to scan a document; and
a display screen in electronic communication with said scanning device, said display screen adapted to display content of said document.

2. A smart wallet in accordance with claim 1 wherein said scanning device may be one of a flatbed scanner, a sheet fed scanner, and a drum scanner.

3. A smart wallet in accordance with claim 1 wherein said document comprises one of an invoice, a receipt, a promotional coupon, a business card, a credit card, a driving license, a car registration document, an insurance card, a hospital identity card, a social security card, a Government issued identity card, and a passport.

4. A smart wallet in accordance with claim 1 wherein said scanning device is positioned adjacent to said display screen on said smart wallet.

5. A smart wallet in accordance with claim 1 wherein said smart wallet is closed by folding said smart wallet between said scanning device and said display screen, and wherein said document may be scanned after said smart wallet is closed.

6. A smart wallet in accordance with claim 1 further comprising a fastener provided in said smart wallet, said fastener adapted to secure said document to said smart wallet to facilitate scanning said document.

7. A smart wallet in accordance with claim 1 further comprising a counterfeit currency bill detection scanner provided in said smart wallet, said counterfeit currency bill detection scanner validates that a currency bill is counterfeit.

8. A smart wallet, said smart wallet comprising:
at least one compartment, said at least one compartment adapted to receive cash;
an electronic receiver coupled to said smart wallet, said electronic receiver adapted to receive a first electronic signal from an electronic device; and
a display screen in electronic communication with said electronic receiver, said display screen adapted to display at least a portion of said first electronic signal.

9. A smart wallet in accordance with claim 8 wherein said first electronic signal includes at least one of a credit card signal, a driving license signal, a car registration signal, an insurance signal, a medical record signal, a linked credit card signal, a business card signal, a barcode signal, a store card signal, a social security data signal, a household budget signal, a current altitude signal, a current local temperature signal, a current local pressure signal, a current stock ticker signal, a current sport score signal, a current news flash signal, a video conferencing signal, a social media notification signal, an advertisement signal, a GPS navigation signal, an e-mail notification signal, a birthday notification signal a calendar appointment signal, and a weather notification signal.

10. A smart wallet in accordance with claim 8 further comprising a control unit in electronic communication with at least one of said electronic receiver and said display screen.

11. A smart wallet in accordance with claim 10 further comprising an electronic transmitter in electronic communication with said control unit, said electronic transmitter adapted to transmit a second electronic signal to said electronic device.

12. A smart wallet in accordance with claim 11 wherein said second electronic signal comprises at least one of a notification signal that a document is about to expire, and an SMS signal.

13. A smart wallet in accordance with claim 8 wherein said electronic device may be a mobile phone.

14. A smart wallet in accordance with claim 8 wherein said display screen may be foldable to facilitate closing said smart wallet.

15. A smart wallet in accordance with claim 8 further comprising a programmable magnetic stripe element coupled to said smart wallet.

16. A smart wallet in accordance with claim 8 further comprising a programmable memory chip coupled to said smart wallet.

17. A smart wallet in accordance with claim 8 further comprising one of a credit card and a gift card coupled to said smart wallet, one of said credit card and said gift card comprising a display panel that digitally displays an available line of credit on one of said credit card and said gift card in real time.

18. A smart wallet in accordance with claim 8 further comprising a GPS device coupled to said smart wallet, said GPS device adapted to determine a geographical location of said smart wallet.

19. A smart wallet, said smart wallet comprising;
at least one compartment, said at least one compartment adapted to receive cash; and
a memory unit, said memory unit adapted to store at least one of credit card data, gift card data, patient data, driving license data, security gate electronic access data, elevator floor authorization data, and insurance data, and wherein said memory unit is in electronic communication with an external scanning device to facilitate extracting at least one of said credit card data, said gift card data, said patient data, said driving license data, said security gate electronic access data, said elevator floor authorization data, and said insurance data by said external scanning device.

20. A smart wallet, said smart wallet comprising:
at least one compartment, said at least one compartment adapted to receive cash;
a memory unit;
a display screen in electronic communication with said memory unit; and
a touch screen selector in electronic communication with said display screen, said touch semen selector adapted to provide access to a user when one of;
a user's fingerprint matches with said user's fingerprint that is stored within said memory unit; and
a first unique drawing pattern that is keyed by said user matches with a second unique drawing pattern that is stored within said memory unit.

21. A smart wallet, said smart wallet comprising:
at least one compartment, said at least one compartment adapted to receive cash;
a display screen; and
an electronic receiver in electronic communication with said display screen, said electronic receiver in electronic communication with a device worn by a user, said electronic receiver facilitates providing access to an operating system of the smart wallet to the user when said device worn by the user is lesser than a pre-programmed displacement from said electronic receiver.

22. A smart wallet, said smart wallet comprising;
at least one compartment, said at least one compartment adapted to receive cash;
one of an electronic receiver and an electronic keypad coupled to said smart wallet, one of said electronic receiver and said electronic keypad adapted to receiver financial information pertaining to a household budget, one of said electronic receiver and said electronic keypad further adapted to receive financial information pertaining to actual currency spent;
a memory unit in electronic communication with one of said electronic receiver and said electronic keypad, said memory unit adapted to store financial information pertaining to said household budget and financial information pertaining to actual currency spent;
a control unit in electronic communication with said memory unit, said control unit adapted to subtract the financial information pertaining to actual currency spent from the financial information pertaining to said household budget; and
a display screen in electronic communication with said control unit, said display screen adapted to display thereby notifying a user when one of:
the financial information pertaining to actual currency spent approaches the financial information pertaining to said household budget; and
the financial information pertaining to actual currency spent equals/exceeds the financial information pertaining to said household budget.

23. A smart wallet in accordance with claim 22 wherein said display screen is adapted to display a consolidated statement of the financial information pertaining to actual currency spent at an end of a pre-defined time period.

24. A smart wallet in accordance with claim 22 further comprising an electronic transmitter in electronic communication with said control unit, said electronic transmitter adapted to transmit payment information pertaining to one of a utility bill and a credit card bill to a mobile phone.

25. A smart wallet in accordance with claim 22 wherein said smart wallet is manufactured from a material comprising one of leather, canvas, plastic, rexene, nylon, rubber, polyester, felt, and silk.

26. A smart wallet in accordance with claim 22 wherein one of said electronic receiver and
said electronic keypad is adapted to receive financial information pertaining to cash spent by a user, and wherein said memory unit is adapted to store financial information pertaining to cash spent by the user.

27. A smart wallet, said smart wallet comprising:
at least one compartment, said at least one compartment adapted to receive cash;
a memory unit, said memory unit adapted to store information pertaining to at least one merchant;
a control unit in electronic communication with said memory unit;
one of a selector switch and a touch screen selector in electronic communication with said control unit, one of said selector option switch and said touch screen selector operable by a user to select said at least one merchant; and
a display screen in electronic communication with said control unit, said display screen adapted to display at least one of a list of recent transactions associated with said at least one merchant and total currency that is due to be paid by said at least one merchant.

28. A smart wallet in accordance with claim 27 further comprising:
a GPS device coupled to said smart wallet, said GPS device adapted to determine a geographical location of said smart wallet;
said control unit in electronic communication with said GPS device, wherein one of said GPS device and said control unit adapted to determine if the geographical location of said smart wallet is proximate to at least one merchant address of said at least one merchant; and
said display screen adapted to display thereby notifying the user if the geographical location of said smart wallet is proximate to said at least one merchant address of said at least one merchant.

29. A smart wallet, said smart wallet comprising:
at least one compartment, said at least one compartment adapted to receive cash; and
at least one component, said at least one component comprising a heart rate transducer, a fitness tracker, a digital music player, an electrically powered heating element, a flash light, a camera, a microphone, a GPS device, and an AM/FM radio receiver.
